(19) United States
(12) Patent Application Publication
(10) Pub. No.: US 2014/0105712 A1
(43) Pub. Date: Apr. 17, 2014

(54) JIG UNIT FOR FIXING SUBSTRATE AND SUBSTRATE TRANSFER APPARATUS INCLUDING THE SAME

(71) Applicant: SAMSUNG ELECTRO-MECHANICS CO., LTD., Suwon (KR)

(72) Inventors: Sung Taek Lim, Suwon (KR); Sang Yup Lee, Busan (KR); Youn Chul Nam, Suwon (KR); Sung Joon Lee, Busan (KR); Going Sik Kim, Yongin (KR); Byeong Mun Kim, Busan (KR)

(73) Assignee: SAMSUNG ELECTRO-MECHANICS CO., LTD., Suwon (KR)

(21) Appl. No.: 14/019,032

(22) Filed: Sep. 5, 2013

(30) Foreign Application Priority Data
Oct. 15, 2012 (KR) 10-2012-0114184

(51) Int. Cl. B66F 9/18

(52) U.S. Cl. CPC G03G 15/2085
USPC 414/621

(57) ABSTRACT

The present invention relates to a jig unit for fixing a substrate and a substrate transfer apparatus including the same. In accordance with an embodiment of the present invention, a jig unit for fixing a substrate including: a support part for supporting an edge-side lower portion of a substrate; a hinge part having a hinge formed at a predetermined height from an upper surface of the substrate supported to the support part and rotating so that a rotation range by the hinge applies a force to the edge side of the substrate beyond the range that vertically presses the upper surface of the substrate; and a substrate fixing part for fixing the substrate to the support unit flatly by applying tension to the edge side of the substrate simultaneously with pressing the upper surface of the substrate is provided.

### CROSS-REFERENCE TO RELATED APPLICATIONS

Claim and incorporate by reference domestic priority application and foreign priority application as follows:

### Cross Reference To Related Application

This application claims the benefit under 35 U.S.C. Section 119 of Korean Patent Application Serial No. 10-2012-0114184, entitled filed Oct. 15, 2012, which is hereby incorporated by reference in its entirety into this application.

### BACKGROUND OF THE INVENTION

1. Field of the Invention

The present invention relates to a jig unit for fixing a substrate and a substrate transfer apparatus including the same, and more particularly, to a jig unit for fixing a substrate that can maintain a substrate flat by applying tension, and a substrate transfer apparatus including the same.

2. Description of the Related Art

In situations where the use of thin package (PKG) substrates increases, warpage is becoming more serious than conventional thick base PKG substrates. Especially, in the thin PKG substrate, warpage in general handling becomes serious in curing and drying processes including high temperature processes due to characteristics of a very thin core substrate of about 100 to 200 μm, ultimately having a serious impact on yield and quality of products.

Accordingly, in the substrate processes including the high temperature processes, manual operations are excluded as many as possible and input, mounting, and demounting of the substrate are continuously automatically performed.

Although an apparatus for fixing and transferring a substrate by a jig is used to continuously automatically perform the input, mounting, and demounting of the substrate while excluding the manual operations, the jigs used in the transfer apparatus for performing the high temperature processes of the substrate, for example, a thin substrate may cause serious problems that are typically not problems in jigs for a thick substrate. For example, when the substrate is mounted on the jig in a state in which flatness of the substrate is not secured, warpage given to the substrate when being mounted on the jig exists as it is, thus being serious warpage while passing through the high temperature processes.

FIG. 7 is a view schematically showing a conventional jig unit. While a jig 3 is installed on a frame 2, a fixing part 3b of the jig 3 presses a substrate 1 in the vertical direction to fix the substrate 1 by rotation of a hinge 3a of the jig 3. In the prior art, when fixing a substrate, for example, a thin substrate to the jig unit as in FIG. 7, the substrate is automatically positioned using two jigs on upper and lower sides of the substrate and the jigs are closed to fix the substrate. At this time, if the substrate is incorrectly mounted, serious warpage of the substrate occurs. When the substrate passes through high temperature processes as it is, the initial warpage becomes more serious while passing through the thermal processes, consequently bring the result of adherence of unexpected failure.

### RELATED ART DOCUMENT

### Patent Document

Patent Document 1: U.S. Patent Laid-open Publication No. US2004/0115035 (laid-open on Jun. 17, 2004)

### SUMMARY OF THE INVENTION

The present invention has been invented in order to overcome the above-described problems and it is, therefore, an object of the present invention to provide a jig unit for fixing a substrate for improvement of substrate warpage that can overcome substrate warpage occurring when mounting a substrate, for example, a thin substrate on a jig unit.

In accordance with a first embodiment of the present invention to achieve the object, there is provided a jig unit for fixing a substrate including: a support part for supporting an edge-side lower portion of a substrate; a hinge part having a hinge formed at a predetermined height from an upper surface of the substrate supported to the support part and rotating so that a rotation range by the hinge applies a force to the edge side of the substrate beyond the range that vertically presses the upper surface of the substrate; and a substrate fixing part formed on an end of a rotating body of the hinge part and fixing the substrate to the support unit flatly by applying tension to the edge side of the substrate simultaneously with pressing the upper surface of the substrate according to the rotation of the hinge of the hinge part.

At this time, in an example, the hinge part may include a support frame having one end fixed to one side of the support part and extending to an upper side of the support part; a hinge formed on the other end of the support frame at a predetermined height from the upper surface of the substrate; and a rotating frame having one end connected to the hinge and the substrate fixing part formed on the other end to be rotated by the hinge, wherein the substrate fixing part rotates to a rotation angle that applies tension to the edge side of the substrate beyond the range that vertically presses the upper surface of the substrate.

Further, at this time, the hinge part may further include an elastic body for providing an elastic force to the rotating frame so that the substrate fixing part applies tension to the edge side of the substrate beyond the range that vertically presses the upper surface of the substrate.

Moreover, at this time, the elastic body may be an axial spring formed on the hinge.

Further, in an example, the hinge part may further include a lift-up frame for lifting the rotating frame from the support part to insert the substrate between the support part and the rotating frame.

In accordance with another example, the hinge part may apply a rotary force to increase the tension applied to the substrate by the substrate fixing part according to an increase in the rotation angle of the hinge and maintain the tension without the increase in the rotation angle of the hinge.

At this time, an axial spring may be formed on the hinge, and the axial spring may provide the elastic force to increase the tension according to the increase in the rotation angle of the hinge and maintain the tension without the increase in the rotation angle of the hinge.

Further, in accordance with an example, a height of the hinge of the hinge part may be adjusted according to a thickness of the substrate.

In another example, the substrate fixing part may rotate along with the rotation of the rotating body, and a contact point of the substrate fixing part with the upper surface of the substrate may change according to a change in the rotation angle at which the substrate and the substrate fixing part are in contact with each other.

At this time, at least a surface of the substrate fixing part, which is in contact with the upper surface of the substrate, may have a cross-sectional arc shape.

In addition, at this time, the substrate fixing part may include a plurality of protrusions protruding from the upper surface of the substrate fixing part which has a cross-sectional arc shape, wherein the protrusions may provide tension while pressing the upper surface of the substrate without sliding.

Further, in an example, the support part may have at least one roller for supporting the lower portion of the substrate.

In accordance with another example, at least one of the surface of the support part and the surface of the substrate fixing part, which are in contact with the surface of the substrate, may be made of a Teflon material.

In accordance with a second embodiment of the present invention to achieve the object, there is provided a substrate transfer apparatus for transporting a substrate including: a body frame; and a jig unit for fixing a substrate in accordance with one of the above-described first embodiments installed along the body frame in plural and tightening a substrate to fix the substrate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically showing a jig unit for fixing a substrate in accordance with an embodiment of the present invention;

FIG. 2 is a view schematically showing a configuration of a hinge part of a jig unit for fixing a substrate in accordance with an example of the present invention;

FIG. 3 is a view schematically showing a jig unit for fixing a substrate in accordance with another example of the present invention;

FIG. 4 is a view schematically showing a support part of the jig unit for fixing a substrate in accordance with another example of the present invention;

FIG. 5 is a view schematically showing forces in a substrate fixing part of the jig unit for fixing a substrate in accordance with an example of the present invention;

FIG. 6 is a view schematically showing a portion of a substrate transfer apparatus in accordance with another example of the present invention; and

FIG. 7 is a view schematically showing a conventional jig unit.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

The drawings referenced in this specification are provided as examples to describe the embodiments of the present invention, and the shape, the size, and the thickness may be exaggerated in the drawings for effective description of technical features.

First, a jig unit for fixing a substrate in accordance with a first embodiment of the present invention will be specifically described with reference to the drawings. At this time, the reference numeral that is not mentioned in the reference drawing may be the reference numeral that represents the same element in another drawing.

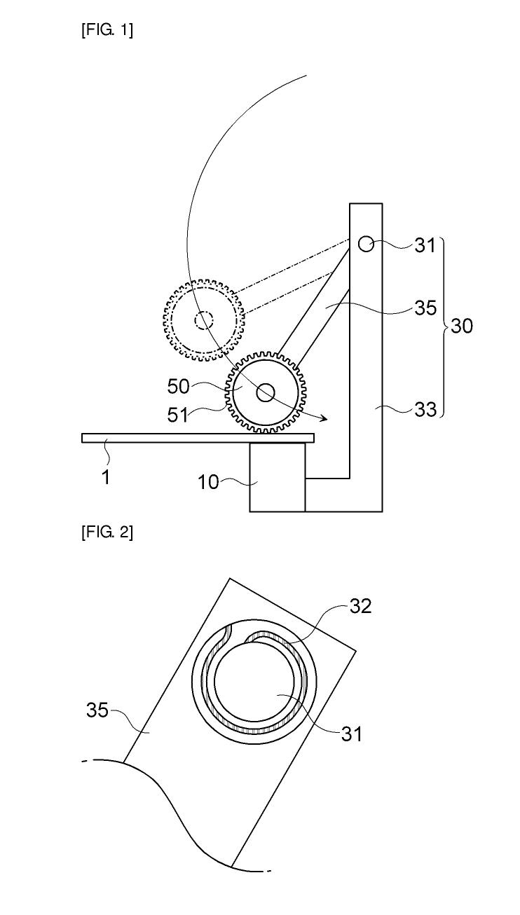

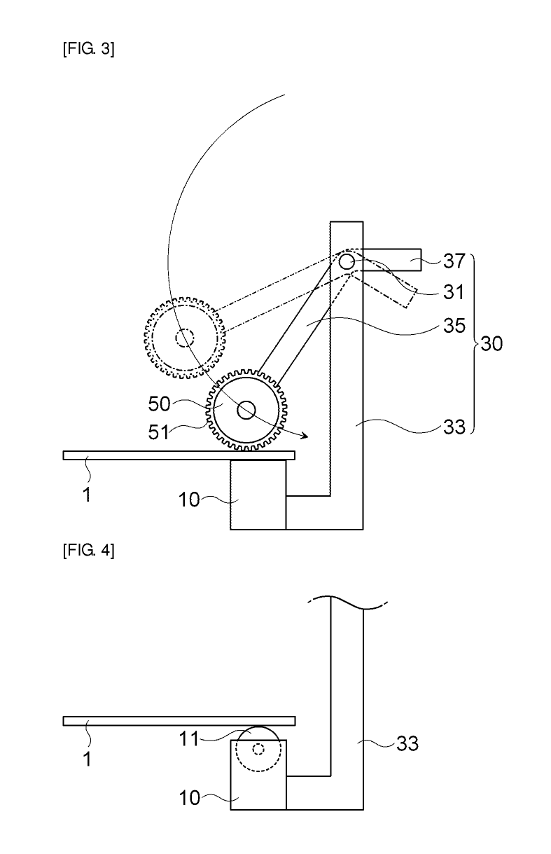

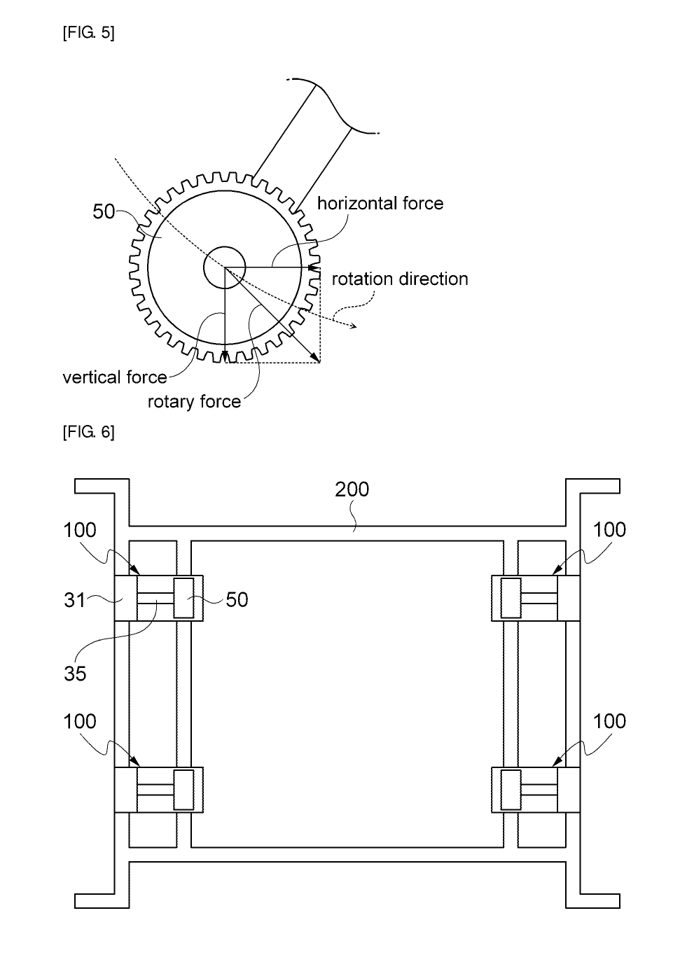

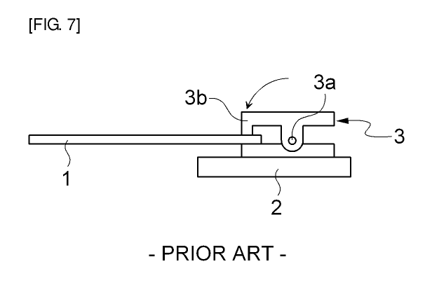

FIG. 1 is a view schematically showing a jig unit for fixing a substrate in accordance with an embodiment of the present invention, FIG. 2 is a view schematically showing a configuration of a hinge part of a jig unit for fixing a substrate in accordance with an example of the present invention, FIG. 3 is a view schematically showing a jig unit for fixing a substrate in accordance with another example of the present invention, FIG. 4 is a view schematically showing a support part of the jig unit for fixing a substrate in accordance with another example of the present invention, and FIG. 5 is a view schematically showing forces in a substrate fixing part of the jig unit for fixing a substrate in accordance with an example of the present invention.

Referring to FIGS. 1 and/or 3, a jig unit for fixing a substrate in accordance with an example includes a support part 10, a hinge part 30, and a substrate fixing part 50.

Specifically describing, at this time, the support part 10 supports an edge-side lower portion of a substrate 1. In FIGS. 1 and/or 3, although it is shown that an area of the support part 10 for supporting the lower portion of the substrate 1 is wide, for example, the support part 10 may be formed to have a narrow flat surface in order to easily flatten the substrate 1.

Referring to FIG. 4, in an example, the support part 10 may have at least one roller 11 for supporting the lower portion of the substrate 1. Accordingly, it is possible to easily flatten the substrate 1 by the hinge part 30 and the substrate fixing part 50.

Further, in an example, a surface of the support part 10, which is in contact with a lower surface of the substrate 1, may be made of a Teflon material. For example, it is possible to reduce friction with the substrate 1 by forming the surface of the support part 10 with a Teflon material, thus easily flattening the substrate 1 by the hinge part 30 and the substrate fixing part 50.

Further, referring to FIGS. 1 and/or 3, a hinge 31 of the hinge part 30 is formed at a predetermined height from an upper surface of the substrate 1 supported to the support part 10. Accordingly, the hinge part 30, specifically a rotating body of the hinge part 30 can rotate so that a rotation range by the hinge 31 reaches the range that can apply a force to the edge side of the substrate 1 beyond the range that vertically presses the upper surface of the substrate 1. That is, since the hinge 31 of the hinge part 30 is formed at a predetermined height from the upper surface of the substrate 1, the substrate fixing part 50 can apply tension in the direction of the edge side of the substrate 1 at the same time while vertically pressing the upper surface of the substrate 1 according to the rotation of the hinge part 30. Accordingly, warpage of the substrate 1 can be reduced and the substrate 1 can be flattened.

Referring to FIG. 5, a rotary force F in the point where the substrate fixing part 50 rotated by the rotating body of the hinge part 30 is in contact with the substrate 1 or fixes the substrate 1 is a resultant of a horizontal force Fh and a vertical force Fv. At this time, since the rotary force F is a resultant of the vertical force Fv and the horizontal force Fh acting in the direction of the edge side (outer side) of the substrate 1, it is possible to apply tension in the direction of the edge side of the substrate 1 by the horizontal force Fh. If the rotary force F is equal to the vertical force Fv or a resultant of the vertical force Fv and the horizontal force acting in the direction of the center of the substrate as before, it is not possible to provide tension in the direction of the edge side of the substrate 1. At this time, when the rotary force F is equal to the vertical force Fv, the rotation range by the hinge 31 is a rotation range in which only the vertical force Fv acts. When rotating beyond the above range, it is possible to provide tension by the horizontal force Fh in the direction of the edge side of the substrate 1.

At this time, the hinge part 30 will be more specifically described with reference to FIGS. 1, 2, and/or 3. In an example, the hinge part 30 may include a support frame 33, a hinge 31, and a rotating frame 35. Further, referring to FIG. 2, the hinge part 30 may further include an elastic body 32. Referring to FIG. 3, the hinge part 30 may further include a lift-up frame 37.

Referring to FIGS. 1 and/or 3, the support frame 33 extends to an upper side of the support part 10 while having one end fixed to one side of the support part 10. Accordingly, the hinge 31 formed on the other end of the support frame 33 can be formed at a predetermined height from the upper surface of the substrate 1. Further, one end of the rotating frame 35, which is a rotating body of the hinge part 30, is connected to the hinge 31 and the substrate fixing part 50 is formed on the other end of the rotating frame 35 so that the rotating frame 35 is rotated by the hinge 31. According to the rotation of the hinge 31, the rotating frame 35 rotates to a rotation angle in the range in which the substrate fixing part 50 can apply tension to the edge side of the substrate 1 beyond the range that vertically presses the upper surface of the substrate 1.

In accordance with an example, describing with reference to FIG. 2, the hinge part 30 may further include the elastic body 32. At this time, the elastic body 32 provides an elastic force to the rotating frame 35 so that the substrate fixing part 50 can apply tension to the edge side of the substrate 1 beyond the range that vertically presses the upper surface of the substrate 1. By the elastic force of the elastic body 32, it is possible to increase tension acting in the edge-side horizontal direction of the substrate 1 as well as a vertical force acting in the vertical direction in the point where the rotating frame 35 is in contact with the upper surface of the substrate 1. Accordingly, the warpage of the substrate 1 can be minimized and the substrate 1 can be further flattened on the support part 10.

For example, at this time, the elastic body 32 may be an axial spring formed on the hinge or the hinge axis 31. The axial spring 32 is an example of the elastic body and an elastic body having a different structure can be used. Referring to FIG. 2, the axial spring 32 is formed inside the hinge or on an outer circumference of the hinge axis 31 to transmit a rotary force to the rotating frame 35 connected to the axial spring 32, and the rotating frame 35 which receives the rotary force of the axial spring 32 rotates to the range in which the substrate fixing part 50 can apply tension to the edge side of the substrate 1 beyond the range that vertically presses the upper surface of the substrate 1.

Further, FIG. 3 will be described. At this time, in accordance with an example, the hinge part 30 may further include the lift-up frame 37. At this time, the lift-up frame 37 lifts the rotating frame 35 from the support part 10 to insert the substrate 1 between the support part 10 and the rotating frame 35. The lift-up frame 37 may be formed in the shape that the rotating frame 35 extends to an opposite side of the hinge or although not shown, the lift-up frame 37 may be formed in the shape separately connected to the rotating frame 35. The lift-up frame 37 may operate opposite to the direction of lift-up operation of the rotating frame 35 or in the same direction as the direction of the lift-up operation of the rotating frame 35 through an intermediate medium.

In another example, the hinge part 30 may apply a rotary force so that the tension applied to the substrate 1 by the substrate fixing part 50 is increased according to an increase in the rotation angle of the hinge and then maintained from a predetermined range without the increase in the rotation angle of the hinge. For example, the hinge part 30 may increase the rotary force to a certain range of the rotation angle of the hinge and then apply the rotary force in the opposite direction from the rotation angle beyond the predetermined range. Accordingly, since the rotary force is applied in the opposite direction from the point where the rotation angle of the hinge exceeds the predetermined range, the tension applied to the substrate 1 is increased according to the increase in the rotation angle of the hinge and then maintained from the predetermined range without the increase in the rotation angle of the hinge. Consequently, although a certain degree of tension is provided to prevent the warpage of the substrate 1, the tension can be constantly maintained without the increase in the rotation angle of the hinge from the predetermined range of the rotation angle of the hinge to prevent the additional warpage of the substrate 1 due to the continuous unnecessary increase in the tension.

For example, referring to FIG. 2, in an example, since the axial spring 32 is formed on the hinge or the hinge axis 31, it is possible to constantly maintain the tension without the increase in the rotation angle of the hinge from the predetermined range of the rotation angle of the hinge. Generally, the axial spring 32 provides a forward rotary force by an elastic force to a rotation angle in a certain range but provides an elastic force to rotate in the opposite direction when exceeding the certain range. Accordingly, the axial spring 32 can provide an elastic force to increase the tension according to the increase in the rotation angle of the hinge and maintain the tension without the increase in the rotation angle of the hinge from the predetermined range. At this time, the point where the increase in the rotation angle of the hinge is stopped is a point where a force acting in the horizontal direction toward the center of the substrate by the weight of the substrate 1 is parallel to tension by an elastic force or/and a rotary force. Accordingly, it is possible to prevent the additional warpage of the substrate 1 due to the unnecessary tension while minimizing the warpage of the substrate 1.

Although not shown, in accordance with another example, a height of the hinge of the hinge part 30 can be adjusted according to a thickness of the substrate 1. That is, it is possible to increase the tension generated by the rotary force of the rotating body of the hinge part 30 to a predetermined size and maintain the increased tension by adjusting the height of the hinge 30 according to the thickness of the substrate 1.

Continuously, the substrate fixing part 50 of the jig unit for fixing a substrate will be described. Referring to FIG. 1, the substrate fixing part 50 is formed on an end of the rotating body of the hinge part 30. At this time, the substrate fixing part 50 can fix the substrate 1 to the support part 10 while flattening the substrate 1 by applying tension in the direction of the edge side of the substrate 1 simultaneously with pressing the upper surface of the substrate 1 according to the rotation of the hinge of the hinge part 30. In FIG. 1, although it is shown that the substrate fixing part 50 is connected to the end of the rotating frame 35 which is the rotating body of the hinge part 30, on the contrary, the substrate fixing part 50 may be integrally formed with the rotating frame 35 by processing the end of the rotating body of the hinge part 30, for example, the rotating frame 35.

Forces acting in the substrate fixing part 50 will be described with reference to FIG. 5. The substrate fixing part 50 is rotated according to the rotation of the rotating body of the hinge part 30, for example, the rotating frame 35. At this time, a rotary force F of the substrate fixing part 50 in the point where the substrate fixing part 50 is in contact with an upper portion of the substrate 1 is transmitted to the upper portion of the substrate 1. The rotary force F of the substrate fixing part 50 consists of a vertical force Fv that vertically presses the substrate 1 and a horizontal force Fh that acts in the direction of the edge side of the substrate 1. At this time, the horizontal force Fh acting in the direction of the edge side of the substrate 1 becomes tension acting on the substrate 1. The substrate 1 can be fixed by the substrate fixing part 50 while being flattened by the horizontal force Fh or the tension acting in the direction of the edge side of the substrate 1.

At this time, the substrate fixing part 50 will be more specifically described with reference to FIG. 1. In an example, the substrate fixing part 50 rotates along with the rotation of the rotating body. At this time, a contact point of the substrate fixing part 50 which is in contact with the upper surface of the substrate 1 may change according to a change in the rotation angle at which the substrate 1 and the substrate fixing part 50 are in contact with each other.

For example, at least the contact portion of the substrate fixing part 40 with the upper surface of the substrate 1, that is, the surface of the substrate fixing part 50, which is in contact with the upper surface of the substrate 1, has a cross-sectional arc shape. Thus, the contact point of the substrate fixing part 50, which is in contact with the upper surface of the substrate 1, is changed according to the change in the rotation angle. Further, at least the surface of the substrate fixing part 50, which is in contact with the upper surface of the substrate 1, has a cross-sectional arc shape, thus reducing the area in contact with the upper surface of the substrate 1. For example, in FIG. 1, although the substrate fixing part 50 is shown as a cross-sectional arc shape, it is enough that at least the surface of the substrate fixing part 50 in contact with the upper surface of the substrate 1 has a cross-sectional arc shape without being limited thereto.

In addition, referring to FIG. 1, the substrate fixing part 50 may include a plurality of protrusions 51 protruding from the upper surface of the substrate fixing part 50 which has a cross-sectional arc shape. At this time, the protrusion 51 may provide tension by pressing the upper surface of the substrate 1 without sliding. The protrusion 51 may be formed by an uneven portion formed on the surface of the substrate fixing part 50 or attached to protrude from the surface of the substrate fixing part 50. Further, since it is enough that the protrusion 51 has a cross-sectional protrusion shape, the protrusion 51 may protrude long in the longitudinal direction along the surface of the substrate fixing part 50. Accordingly, it is possible to prevent the substrate 1 from being easily separated from the jig unit for fixing a substrate.

Further, in accordance with an example, the surface of the substrate fixing part 50, which is in contact with the upper surface of the substrate 1, may be made of a Teflon material or a low friction material. At this time, it is possible to prevent even the low friction surface from being obstacle in transmitting the tension provided by the rotating body of the hinge part 30, for example, the rotating frame 35 to the substrate 1.

Next, a substrate transfer apparatus in accordance with a second embodiment of the present invention will be described with reference to the drawings. At this time, the jig unit for fixing a substrate in accordance with the first embodiment described above and FIGS. 1 to 5 are will be referenced. Thus, repeated descriptions may be omitted.

FIG. 6 is a view schematically showing a portion of a substrate transfer apparatus in accordance with another example of the present invention.

Referring to FIG. 6, in accordance with an example, a substrate transfer apparatus for transporting a substrate 1 includes a body frame 200 and a jig unit 100 for fixing a substrate. At this time, the jig unit 100 for fixing a substrate may be installed in plural along the body frame 200 and fix the substrate 1 by tightening the substrate 1. For example, the body frame 200 may be formed of a rectangular frame, and the jig units 100 for fixing a substrate may be installed along the body frame 200 formed of a rectangular frame. The drawing shown in FIG. 6 may be one frame installed in a tray of the substrate transfer apparatus or may be one substrate transfer apparatus itself according to the embodiments. Specific description of the jig unit 100 for fixing a substrate will refer to the above-described first embodiments and FIGS. 1 to 5.

At this time, the substrate transfer apparatus may be, for example, an apparatus for transporting a substrate used in a high temperature process of a thin substrate (reference numeral 1 of FIG. 1).

As described above, according to the embodiment of the present invention, warpage itself can be naturally flattened due to the operation of a hinge part and a substrate fixing part when a substrate, for example, a thin substrate is fixed to the jig unit.

Further, if tension is continuously increased when fixing the substrate, it acts as another warpage inducing factor when passing through a high temperature process. According to an embodiment, since the substrate is fixed in the position where the increased tension is constantly maintained by disposing, for example, an axial spring, in the hinge part and the additional tension does not act by the substrate fixing part, it is possible to prevent the unnecessary additional tension, which can cause the additional warpage, from being applied while minimizing the warpage of the substrate.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

1. A jig unit for fixing a substrate, comprising:
a support part for supporting an edge-side lower portion of a substrate;
a hinge part having a hinge formed at a predetermined height from an upper surface of the substrate supported to the support part and rotating so that a rotation range by the hinge applies a force to the edge side of the substrate beyond the range that vertically presses the upper surface of the substrate; and
a substrate fixing part formed on an end of a rotating body of the hinge part and fixing the substrate to the support unit flatly by applying tension to the edge side of the substrate simultaneously with pressing the upper surface of the substrate according to the rotation of the hinge of the hinge part.

2. The jig unit for fixing a substrate according to claim 1, wherein the hinge part comprises:
a support frame having one end fixed to one side of the support part and extending to an upper side of the support part;
a hinge formed on the other end of the support frame at a predetermined height from the upper surface of the substrate; and
a rotating frame having one end connected to the hinge and the substrate fixing part formed on the other end to be rotated by the hinge, wherein the substrate fixing part rotates to a rotation angle that applies tension to the edge side of the substrate beyond the range that vertically presses the upper surface of the substrate.

3. The jig unit for fixing a substrate according to claim 2, wherein the hinge part further comprises:
an elastic body for providing an elastic force to the rotating frame so that the substrate fixing part applies tension to the edge side of the substrate beyond the range that vertically presses the upper surface of the substrate.

4. The jig unit for fixing a substrate according to claim 3, wherein the elastic body is an axial spring formed on the hinge.

5. The jig unit for fixing a substrate according to claim 2, wherein the hinge part further comprises:
a lift-up frame for lifting the rotating frame from the support part to insert the substrate between the support part and the rotating frame.

6. The jig unit for fixing a substrate according to claim 1, wherein the hinge part applies a rotary force to increase the tension applied to the substrate by the substrate fixing part according to an increase in the rotation angle of the hinge and maintain the tension without the increase in the rotation angle of the hinge.

7. The jig unit for fixing a substrate according to claim 6, wherein an axial spring is formed on the hinge, and the axial spring provides an elastic force to increase the tension according to the increase in the rotation angle of the hinge and maintain the tension without the increase in the rotation angle of the hinge.

8. The jig unit for fixing a substrate according to claim 1, wherein a height of the hinge of the hinge part is adjusted according to a thickness of the substrate.

9. The jig unit for fixing a substrate according to claim 1, wherein the substrate fixing part rotates along with the rotation of the rotating body, and a contact point of the substrate fixing part with the upper surface of the substrate changes according to a change in the rotation angle at which the substrate and the substrate fixing part are in contact with each other.

10. The jig unit for fixing a substrate according to claim 9, wherein at least a surface of the substrate fixing part, which is in contact with the upper surface of the substrate, has a cross-sectional arc shape.

11. The jig unit for fixing a substrate according to claim 10, wherein the substrate fixing part comprises a plurality of protrusions protruding from the upper surface of the
substrate fixing part which has a cross-sectional arc shape, wherein the protrusions provide tension while pressing the upper surface of the substrate without sliding.

12. The jig unit for fixing a substrate according to claim 1, wherein the support part has at least one roller for supporting the lower portion of the substrate.

13. The jig unit for fixing a substrate according to claim 1, wherein at least one of the surface of the support part and the surface of the substrate fixing part, which are in contact with the surface of the substrate, is made of a Teflon material.

14. A substrate transfer apparatus for transporting a substrate, comprising:
a body frame; and
a jig unit for fixing a substrate according to claim 1 installed along the body frame in plural and tightening a substrate to fix the substrate.

15. A substrate transfer apparatus for transporting a substrate, comprising:
a body frame; and
a jig unit for fixing a substrate according to claim 2 installed along the body frame in plural and tightening a substrate to fix the substrate.

16. A substrate transfer apparatus for transporting a substrate, comprising:
a body frame; and
a jig unit for fixing a substrate according to claim 3 installed along the body frame in plural and tightening a substrate to fix the substrate.

17. A substrate transfer apparatus for transporting a substrate, comprising:
a body frame; and
a jig unit for fixing a substrate according to claim 4 installed along the body frame in plural and tightening a substrate to fix the substrate.

18. A substrate transfer apparatus for transporting a substrate, comprising:
a body frame; and
a jig unit for fixing a substrate according to claim 5 installed along the body frame in plural and tightening a substrate to fix the substrate.

19. A substrate transfer apparatus for transporting a substrate, comprising:
a body frame; and
a jig unit for fixing a substrate according to claim 6 installed along the body frame in plural and tightening a substrate to fix the substrate.

20. A substrate transfer apparatus for transporting a substrate, comprising:
a body frame; and
a jig unit for fixing a substrate according to claim 7 installed along the body frame in plural and tightening a substrate to fix the substrate.
